(19) United States
(12) Patent Application Publication
(10) Pub. No.: US 2016/0124987 A1
(43) Pub. Date: May 5, 2016

(54) ACCESS CONTROL BASED ON REQUESTOR LOCATION

(71) Applicant: Microsoft Corporation, Redmond, WA (US)

(72) Inventor: Graham Charles Plumb, London (GB)

(21) Appl. No.: 14/529,049

(22) Filed: Oct. 30, 2014

(51) Int. Cl. G06F 17/30

(52) U.S. Cl. CPC G06F 17/30168; G06F 17/30212

(57) ABSTRACT

File system entity access control based on location of the requestor. Location data is associated with a file system entity (e.g., a file, a directory, a partition, or a disk) such that the file system entity and the location data are moved or copied atomically together. Upon receiving a request to perform an operation on the file system entity, the system identifies the location of the requestor, and accesses the location data associated with the file system entity. The location data and the requestor location are then used to determine whether or not the requested file operation is to be permitted.

### BACKGROUND

Computing systems and associated networks have revolutionized the way human beings work, play, and communicate. Nearly every aspect of our lives is affected in some way by computing systems. The proliferation of networks has allowed computing systems to share data and communicate, vastly increasing information access. For this reason, the present age is often referred to as the “information age”.

However, in some cases, it is desirable to restrict access to data. For instance, data is often restricted so that it is only accessible by certain individuals. Those individuals must therefore authenticate before accessing the data. In other circumstances, data is to be restricted based on location. For instance, some data is to be confined within certain geographical territory. Confinement of data to a particular geographic region may be performed for a variety of reasons, such as legal, regulatory, tax or safety reasons.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the controlling of access to data based on location of the requestor. Location data is associated with a file system entity (e.g., a file, a directory, a partition, or a disk) such that the file system entity and the location data are moved or copied atomically together. Upon receiving a request to perform an operation on the file system entity, the system identifies the location of the requestor, and accesses the location data associated with the file system entity. The location data and the requestor location are then used to determine whether or not the requested file operation is to be permitted.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a system in which a requesting system requests to perform an operation on a file system entity that is within a file system of a source system;

FIG. 3 illustrates a file system entity environment in which the file system entity and corresponding location data are associated in such a way that if the file system entity is copied or moved, the corresponding location data is also atomically copied or moved, respectively.

FIG. 4 illustrate location data that represents an example of the location data of FIG. 3;

FIG. 5 illustrates a flowchart of a method for controlling access to data based on location of the requestor; and

FIG. 6 illustrates a flowchart of a method for using the location data to determine whether or not the requested operation is permitted.

### DETAILED DESCRIPTION

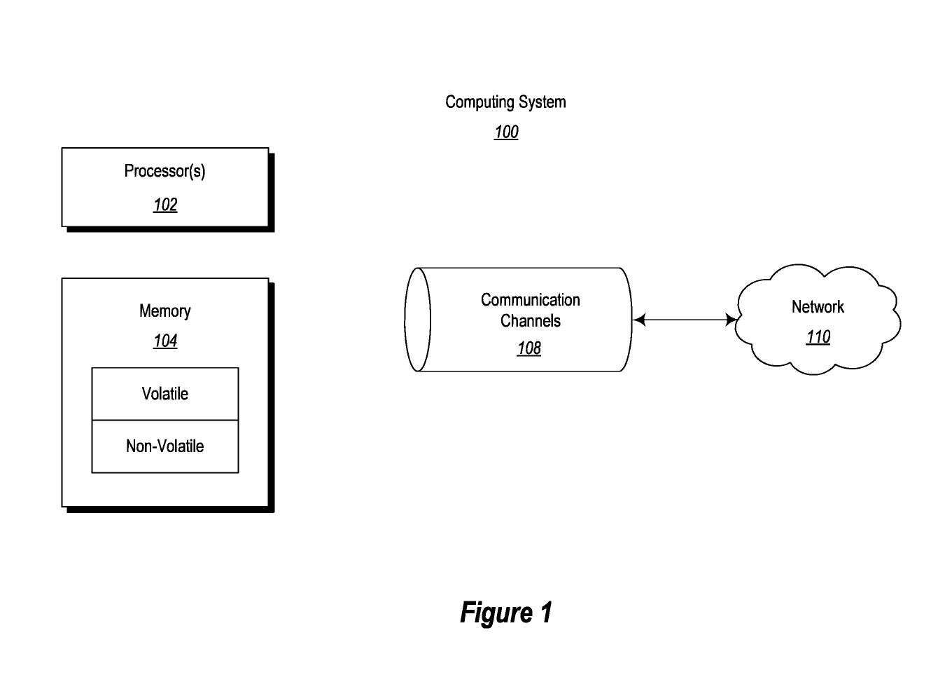

At least some embodiments described herein relate to the controlling of access to data based on location of the requestor. Location data is associated with a file system entity (e.g., a file, a directory, a partition, or a disk) such that the file system entity and the location data are moved or copied atomically together. Upon receiving a request to perform an operation on the file system entity, the system identifies the location of the requestor, and accesses the location data associated with the file system entity. The location data and the requestor location are then used to determine whether or not the requested file operation is to be permitted. Some introductory discussion of a computing system will be described with respect to FIG. 1. Then, the structure and use of access control will be described with respect to subsequent figures.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors (of the associated computing system that performs the act) direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other computing systems over, for example, network 110. The computing system 100 also includes a display, which may be used to display visual representations to a user.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

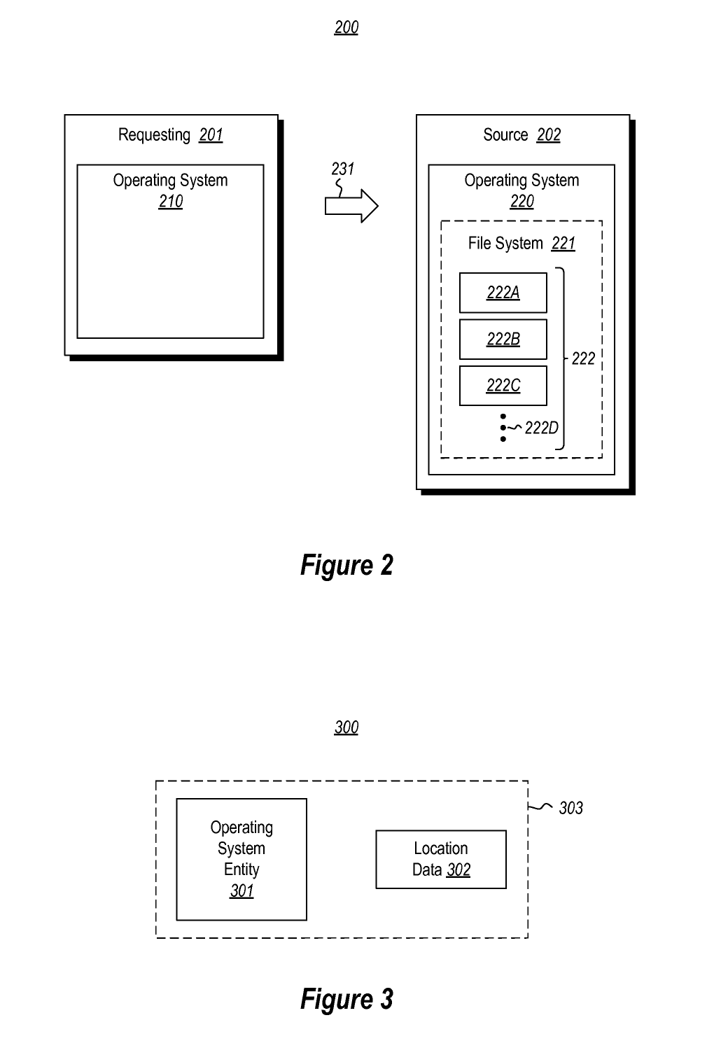

FIG. 2 illustrates a system 200 that includes a requesting system 201 and a source system 202. In particular, the requesting system 201 submits a request 231 to the source system 202 to perform an operation on a file system entity of the source system 202. Examples of such operations might include, for instance, read operations, update operations, copy operations, and delete operations. The file system entity might be, for example, a disk, a partition, a directory, or the most basic file system entity—a file.

The requesting system 201 may be a computing system, in which case the requesting system 201 and may be structured as described above for the computing system 100 of FIG. 1. If a computing system, the requesting system 201 operates thereon an operating system 210. The source system 202 includes an operating system 220 that maintains a file system 221 constituting multiple file system entities 222. For instance, the file system 221 is illustrated as including multiple file system entities 222 including file system entity 222A, file system entity 222B, file system entity 222C, amongst potentially many other file system entities as represented by the ellipses 222D.

FIG. 3 illustrates a file system entity environment 300. The file system entity environment 300 includes a file system entity 301 as well as location data 302. Furthermore, the location data 302 is associated with the file system entity as represented by the dashed box 303. This association 303 is such that the file system entity 301 and the location data 302 are moved or copied atomically together. As an example, the file system entity 301 might be any of the file system entities 222 of FIG. 2. A similar file system entity environment 300 may be provided for each of multiple file system entities, such that the file system entity has associated location data which is atomically moved or copied with the file system entity if the file system entity is moved or copied.

The association 303 may differ depending on the file system. In one example, in which the file system entity is a file, the association 303 is accomplished by including the location data within an alternate data stream of the file. Such might be appropriate for instance, in a New Technology File System (NTFS)-based file system. As another example, the association 303 may be accomplished by including the location data as one or more properties of the file system entity. For instance, in inode-based file systems such as XFS, ZFS and Reiser4, this location data may be stored against a file using extended file properties.

For file systems which do not provide an extension to a given file system entity entry's content (such as FAT16, FAT32 and ExFAT), a fallback approach may be used where the location data is written to a separate file in the same directory as the file system entity (e.g., using an appropriate extension). While this is not as robust as the other approaches, it does offer some level of interoperability for legacy systems—although location-based data access enforcement will be at the mercy of the consuming operating system.

It is not important to the principles described herein how the association 303 is made between the file system entity 301 and the location data 302. Suffice it to say that regardless of how the association is made, the association is compatible with the underlying file system or environment, and is made such that if the file system entity 301 is moved or copied, so is the location data 302.

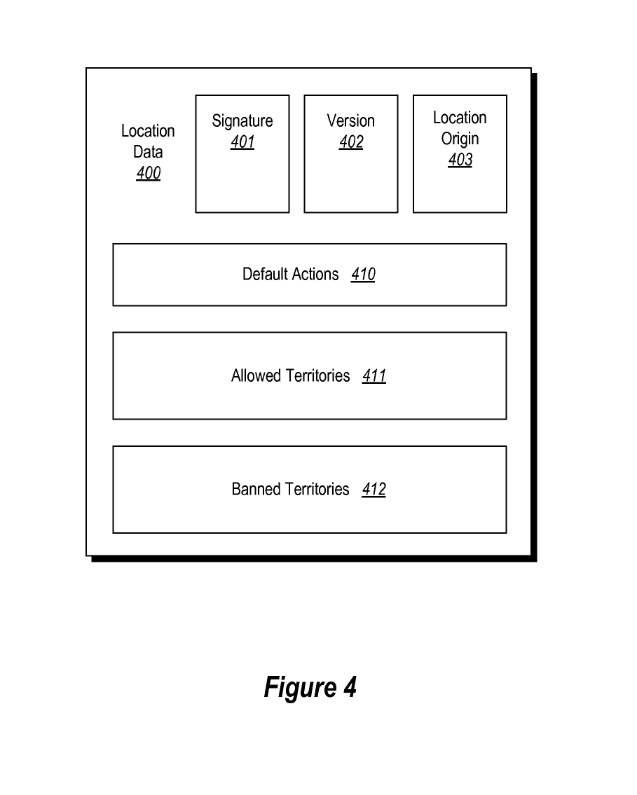

FIG. 4 illustrate location data 400 that represents an example of the location data 302 of FIG. 3. The location data 400 includes various fields that are examples of what might be included in various embodiments. There is no requirement that the location data described herein include all, or even some, of the fields described for the location data 400.

The location data 400 includes a signature 401 that perhaps allows metadata to be identified as pertaining to time-restricted access. A version 402 field might identify the version number so as to allow advancement of the principles described herein. A location origin field 403 may identify a region at which the file system entity originated. This might be useful in situations in which access may depend on whether the location of the requestor is the same region that originated the file system entity.

The location data 400 also includes a default actions field 410 that defines what actions may be taken on the file system entity when the location of the requestor cannot be determined, or in which the requested operation is not expressly allowed in an allowed territories list 411 or expressly banned in a banned territories list 412. As an example, the default actions field 410 might simply have values from 0 to 15 (constituting four bits—also called a “nibble”). If all of the four bits are zero, then there are no default actions permitted. If the least significant bit is set (e.g., the nibble has a value of 1, 3, 5, 7, 9, 11, 13 or 15), then a copy operation is permitted as a default operation. If the second least significant bit is set (e.g., the nibble has a value of 2, 3, 6, 7, 10, 11, 14 or 15), then a read operation is permitted as a default operation. If the second most significant bit is set (e.g., the nibble has a value of 4, 5, 6, 7, 12, 13, 14 or 15), then an update operation is permitted as a default operation. If the most significant bit is set (e.g., the nibble has a value from 8 to 15, inclusive), then a delete operation is permitted as a default operation. This will be referred to hereinafter as the “nibble schema”.

The location data 400 also includes an allowed territory list 411, each allowed territory having a corresponding nibble that complies with the nibble schema described above. Thus, any territory that has at least one allowed operation for requestors located within the territory, the territory will be in the allowed territory list 411. The allowed operations for the territory are defined by the bit being set in accordance with the nibble schema for the nibble corresponding to the allowed territory.

The location data 400 also includes a banned territory list 412, each banned territory having a corresponding nibble that complies with the nibble schema described above. Thus, any territory that has at least one banned operation for requestors located within the territory, the territory will be in the banned territory list 412. The banned operations for the territory are defined by the bit being set in accordance with the nibble schema for the nibble corresponding to the banned territory.

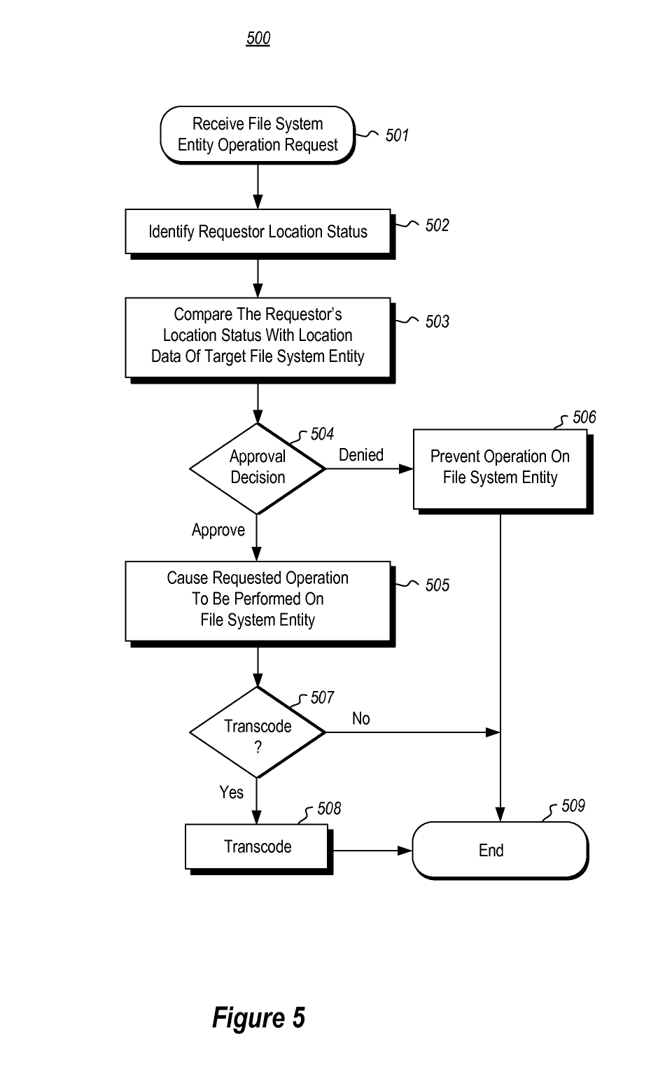

FIG. 5 illustrates a flowchart of a method 500 for controlling access to data based on location of the requestor. The method 500 may be performed by, for example, the source system 202 in order to control access to one of more of the file system entities 222 within its file system 221. Accordingly, the method 500 may be described with frequent reference to the FIG. 2 as an example.

The method 500 is initiated upon the source system receiving a request to perform an operation on the file system entity (act 501). For instance, in FIG. 2, the source system 202 receives the request 231 from the requesting system 201. For instance, suppose the request 231 is to perform a read operation upon the file system entity 222A.

The source system then identifies a location status associated with the requestor that issued the request (act 502). For instance, in FIG. 2, the source system 202 would determine the location status of the requesting entity 201. The location status might be “unknown” in cases in which the location of the requestor is not able to be determined. The location status might also be a particular location or territory where the requestor is presently located.

Then, the source system uses the location data of the file system entity and the requestors' location status to determine whether or not the requested operation is permitted on the file system entity. For instance, referencing FIG. 2, suppose that the file system entity 222A includes a file system entity environment 300, in which the file system entity 222A (or the file system entity 301) has corresponding location data 302. The source system might thus access (e.g., deserialize) the location data 302.

For instance, the source system may compare (act 503) the location status of the requestor (identified in act 502) with the location data of the file system entity that is the target of the request. The source system may then determine (decision block 504) whether or not the requested operation is permitted on the file system entity based on the result of the comparison. If permitted (“Approved” in decision block 504), the source system may cause the requested operation to be performed (act 505). If not permitted (“Denied” in decision block 504), the source system prevents the requested operation (act 506).

In the case of the requested operation being performed, the source system might determine whether or not the file system entity should be transcoded so as to be compatible with the operating system 210 of the requesting system 201 (decision block 507). In the case of the file system operation being a delete, read or update operation, perhaps no transcoding is necessary (“No” in decision block 507), and the method ends (act 509).

However, in the case of a copy operation, the copied version of the file system entity might be transcoded, depending on whether the file system entity environment 300 is the same between the operation systems 210 and 220. If they are not the same, then transcoding is performed so that the location data 302 and the file system entity 301 are associated 303 in a manner suitable for the operating system 210 of the requesting entity, or the ultimate operating system in which the requestor is to use the file system entity. For instance, the copy of the file system entity might have the location data copied from an alternate data stream (if not recognized by the operating system 210) to a file property. In addition, serialization formats might be changed. If the file system entity is serialized in a manner in the source operating system 220 that is not recognized by the requesting operating system 210 (or the operating system in which the requestor intends to use the file system entity), then transcoding in the form or re-serialization might be performed.

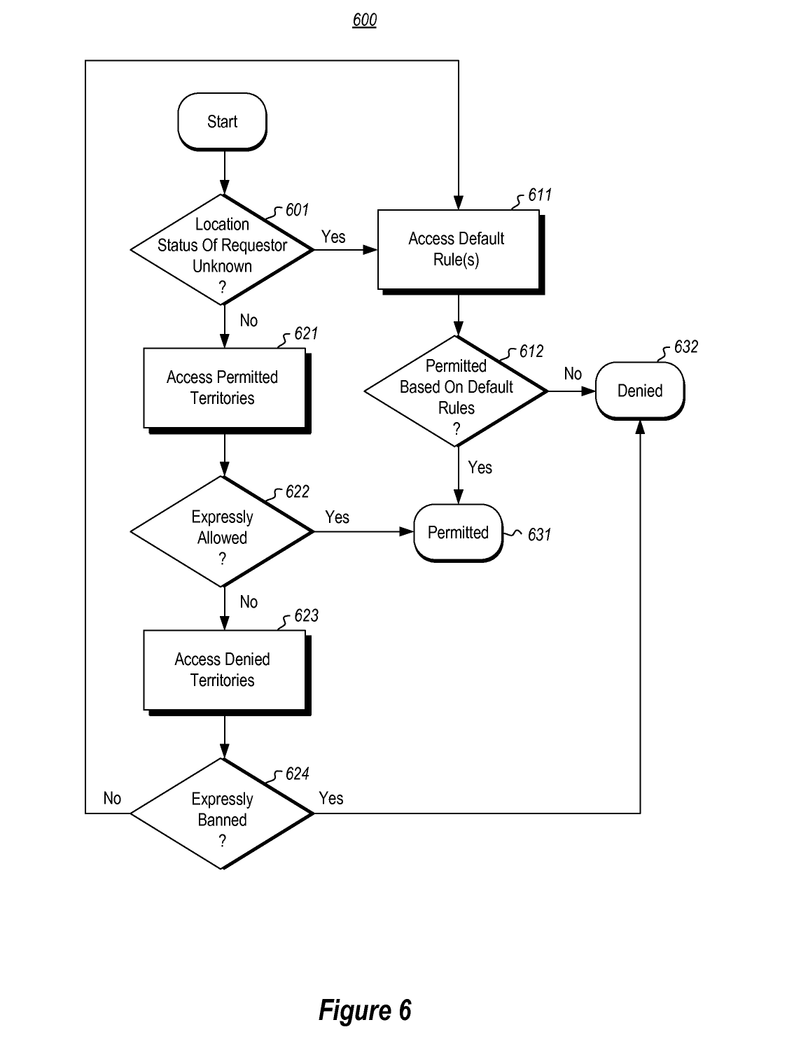

FIG. 6 illustrates a flowchart of a method 600 for using the location data to determine whether or not the requested operation is permitted. The method 600 represents an example of act 503 and decision block 504 of FIG. 5. The method 600 is just one example of how the decision might be made. The principles described herein are not limited to that example.

First, it is determined whether or not the requestors' location status is unknown (decision block 601). If the requestor's location status is unknown (“Yes” in decision block 601), then default rules may then be accessed (act 611) defining whether or not the requested operation may be performed. For instance, such default rules may correspond to the default actions field 410 of the location data in FIG. 4. The default rules are then consulted to determining whether or not the requested operation may be performed based on the default rule (decision block 612). If it can be performed (“Yes” in decision block 612), then the operation is approved (act 631) and otherwise (“No” in decision block), the operation is denied (act 632).

On the other hand, if decision block 601 results in a determination that the location status is a location of the requestor, (i.e., the location status of the requestor is not unknown—“No” in decision block 601), the list of allowed territories (or “permitted locations”) are accessed (act 621). For instance, the source system may access the allowed territories field 411 of the location data 400 corresponding to the file system entity. The source system then determines (decision block 622) whether or not the requested operation is expressly permitted by any of the permitted territories in which the requestors' location is or is within. For instance, in the case of the operation being a read operation, the source system determines whether or not (for a given allowed territory corresponding to the requestors' location), the read operation is indicated as permitted. If the operation is indicated as allowed (“Yes” in decision block 622), then the operation is permitted (act 631).

If there operation is not expressly allowed using the allowed territories (“No” in decision block 622), the list of denied territories (or “denied locations”) are accessed (act 623). For instance, the source system may access the denied territories field 412 of the location data 400 corresponding to the file system entity. The source system then determines (decision block 624) whether or not the requested operation is expressly banned by any of the permitted territories in which the requestors' location is or is within. For instance, in the case of the operation being a read operation, the source system determines whether or not (for a given allowed territory corresponding to the requestors' location), the read operation is indicated as banned. If the operation is indicated as banned (“Yes” in decision block 624), then the operation is denied (act 632). Otherwise (“No” in decision block 624), the method may revert to act 611, to consult default rules. Then, permissibility of the requested operation is determined (decision block 612) in accordance with the default rules.

The principles described herein thus permit data sovereignty to be honored such that operations upon file system entities (e.g., files) may be limited by the location of the requestor. Furthermore, when the operation is permitted, and a copy of the file system is to be made available, the file system entity environment may be transcoded such that the requesting system may also have access to the location data, thereby further enforcing data sovereignty rules.

Having described an example structure of the location data with respect to FIG. 4, three specific serialization implementations will now be described with respect to Tables 1 through 3 respectively. Tables 1A and 1B below illustrates a binary file format for the location data. Table 1A illustrates an example file header format. Table 1B illustrates example supporting data structures.

TABLE 1A

| File Header | | | |
|---|---|---|---|
| Section | Data type | Value | Notes |
| Signature | 3 * byte | GEO | Magic file number to identify this |
| | | | metadata file format |
| Version Info | int | 10 | To be read in the form x.y (10 indicates |
| | | | version 1.0) |
| Country of Origin | int | — | Refers to a UN numeric country code |
| | | | (Eg. 826 is the United Kingdom) |
| Default behavior | int | | A logically OR'd value which determines |
| | | | whether an operation is allowed if a |
| | | | specific territorial rule set is not defined. |
| | | | Flag values: 0 = None, 1 = Copy, 2 = |
| | | | Read, 4 = Update, 8 = Delete. Knowing |
| | | | this, a value of 7 means that copy, read |
| | | | and update operations are allowed, by |
| | | | default. |
| Total allowed territories | int | — | This denotes the size of the “Allowed |
| | | | Territories” list, which follow |
| | | | immediately after this field |
| [Allowed Territory]* | t_struct | | This is a territory struct that repesents |
| | | | an entry in the Allowed Territories list |
| | | | (previously defined) |
| Total banned territories | int | — | This denotes the size of the “Banned |
| | | | Territories” list, which follow |
| | | | immediately after this value |
| [Banned Territory]* | t_struct | | This is a territory struct that repesents |
| | | | an entry in the Banned Territories list |
| | | | (previously defined) |

TABLE 1B
Supporting data types

| Type | | Data | |
|---|---|---|---|
| name | Field Name | type | Notes |
| t_struct | | | Context depends on position in the file |
| | | | header (Eg. Allowed list or Banned list) |
| t_struct | Country | int | Refers to a UN numeric country code |
| | Code | | (Eg. 826 is the United Kingdom) |
| t_struct | Operation | int | A logically OR'd value which determines |
| | flags | | the operations allowed or banned in this |
| | | | territory. Flag values: 0 = None, 1 = |
| | | | Copy, 2 = Read, 4 = Update, 8 = Delete. |
| | | | Knowing this, a value of 7 means that |
| | | | copy, read and update operations are |
| | | | allowed or banned in this territory |
| | | | (based on context) |

Table 2 illustrates a more portable embodiment of the location data using Java-Script Object Notation (JSON).

TABLE 2

| | |
|---|---|
| { | |
| “GEO”: { | //Magic file number denoting metadata file type |
| “version”: “1.0”, | // Metadata file version number |
| “origin”: “826”, | // Country of origin as a UN numberic code |
| | (826 = UK) (example) |
| “default”: “15”, | // Default file operation flags |
| | // A logically OR’d flag list, 0 = None, |
| | //1 = Copy, 2 = Read, 4 = Update, 8 = Delete |
| “allowed”: [ | // List of Allowed Territories (as a JSON array) |
| { | |
| “country”: 826, | // Allowed country, as a UN numeric code |
| | // (826 = UK) (example) |
| “flags”: 15 | // A logically OR’d flag list, 0 = None, |
| | // 1 = Copy, 2 = Read, 4 = Update, 8 = Delete |
| | //In this example, the UK is allowed all file |
| | // operations |
| }, | |
| { | |
| “country”: 784, | // Another allowed country, as a UN numeric |
| | // code (784 = UAE) |
| “flags”: 3 | // In this example, UAE is allowed the read |
| | // operation and the copy operation. |
| } | |
| ], | |
| “banned”: [ | // List of Banned Territories (as a JSON |
| | array) |
| { | |
| “country”: 716, | // Banned country as a UN numeric code (716 = // |
| | Zimbabwe) |
| “flags”: 8 | // This example, the delete file operation is banned |
| | // in Zimbabwe |
| } | |
| ] | |
| } | |
| } | |

The following Table 3 shows a portable example of the location data using an eXtensible Markup Language (XML) document.

```
<?xml version=“1.0” encoding=“utf-8” ?>
<!-- An XML based Geo-Metadata file -->
<GeoMetadata>
    <!-- Metadata version information -->
    <Version>1.0</Version>
    <!-- Country of origin -->
    <Origin>
      <IsoCode>UK</IsoCode>
      <UNCode>826</UNCode>
    </Origin>
    <!-- Default behaviour flags for a file operation not listed in a
territory-specific rule set (Allowed or Banned)
0 = None,
1 = Copy,
2 = Read,
4 = Update (this includes filename, timestamps, metadata and file
contents),
8 = Delete
-->
<DefaultBehaviour>15</DefaultBehaviour>
<!-- A list of allowed territories and their file operation rules -->
<Allowed>
    <!-- There may be more than one <Territory> node at this level -->
    <Territory>
      <IsoCode>UAE</IsoCode>
      <UNCode>784</UNCode>
      <!-- Behaviour flag that indicates what operations are allowed in
      this territory. Here we can see UAE can copy or read a file -->
      <Behaviour>3</Behaviour>
    </Territory>
</Allowed>
<!-- A list of banned territories and their file operation rules -->
<Banned>
  <!-- There may be more than one <Territory> node at this level -->
  <Territory>
    <IsoCode>ZWE</IsoCode>
    <UNCode>716</UNCode>
      <!-- Behaviour flag that indicates what operations are banned in
      this territory. Here we can see Zimbabwe is banned from delete
      operations -->
      <Behaviour>8</Behaviour>
    </Territory>
  </Banned>
</GeoMetadata>
```

Accordingly, a mechanism for preserving sovereignty of data has been described.

### CLAIM SUPPORT SECTION

Described herein is a method for controlling access to data based on location of requestor. Location data is associated with a file system entity such that the location data and the file system entity are moved or copied atomically together. A request is received to perform an operation on the file system entity. The location status associated with a requestor of the request is identified. The location data of the file system entity and the location status of the requestor are used to determine whether or not the requested operation is permitted on the file system entity.

The act of associating location data with the file system entity may include an act of including the location data in an alternate data stream of the file system entity. The act of associating location data with the file system entity may include including the location data as one or more properties of the file system entity.

The act of using the location data of the file system entity and the location status of the requestor to determine whether or not the requested operation is permitted may include: an act of determining that the location status of the requestor is unknown; and in response to determining that the location status of the requestor is unknown, an act of accessing a default rule defining whether or not the requested operation may be performed; and an act of determining whether or not the requested operation may be performed based on the default rule.

The location status of the requestor may be a location of the requestor, in which case the act of using the location data of the file system entity and the location status of the requestor to determine whether or not the requested operation is permitted may further comprising the following: an act of accessing a set of one or more permitted territory each associated with one or more operation types that are permitted; an act of determining that the location of the requestor is within a permitted territory for which the requested operation is expressly permitted; and an act of approving the requested operation if the requested operation is determined to be of an operation type for which the location of the requestor is within any of the corresponding set of one or more permitted locations.

The location status of the requestor may be a location of the requestor, in which case the act of using the location data of the file system entity and the location status of the requestor to determine whether or not the requested operation is permitted further may comprise the following: an act of accessing a set of one or more banned territories each associated with one or more operation types that are banned; an act of determining that the location of the requestor is within a banned territory for which the requested operation is expressly banned; and an act of denying the requested operation if the act requested operation is determined to be of an operation type for which the location of the requestor is within any of the corresponding set of one or more banned locations.

The location status of the requestor may be a location of the requestor, in which case the act of using the location data of the file system entity and the location status of the requestor to determine whether or not the requested operation is permitted may comprise: an act of determining that the location of the requestor is not within an allowed territory for which the requested operation is expressly allowed; an act of determining that the location of the requestor is not within a banned territory for which the requested operation is expressly banned; an act of accessing a default rule defining whether or not the requested operation may be performed; and an act of determining whether or not the requested operation may be performed based on the default rule.

The method may further comprise the following if it is determined that the requested operation is not permitted: an act of preventing the requested operation. The method may further comprise the following if it is determined that the requested operation is permitted: an act of causing the requested operation to be performed. In the latter case, the act of causing the requested operation to be performed may comprises: an act of transcoding the file system entity to be a transcoded file system entity that is suitable for an operating system of the requestor; and/or an act of transcoding the file system entity to be in a serialization implementation that is implemented by an operating system of the requestor.

Also described herein is a computer program product comprising one or more computer-readable storage media having thereon one or more computer-executable instructions that are structured such that, when executed by the one or more processors of the computing system, cause the computing system to perform the following in response to receiving a request to perform an operation on a file system entity that is managed by an operating system, the file system entity having location data associated with the file system entity such that the location data and the file system entity are moved or copied atomically together: an act of identifying a location status associated with a requestor of the request; an act of comparing the location status of the requestor against the location data of the file system entity; and an act of determining whether or not the requested operation is permitted on the file system entity based on a result of the act of comparing.

The location status of the requestor may be a location of the requestor, in which case the act of using the location data of the file system entity and the location status of the requestor to determine whether or not the requested operation is permitted further may comprise the following: an act of accessing a set of one or more permitted territory each associated with one or more operation types that are permitted; an act of determining that the location of the requestor is within a permitted territory for which the requested operation is expressly permitted; and an act of approving the requested operation if the requested operation is determined to be of an operation type for which the location of the requestor is within any of the corresponding set of one or more permitted locations.

The location status of the requestor may be a location of the requestor, in which case the act of using the location data of the file system entity and the location status of the requestor to determine whether or not the requested operation is permitted further may comprise the following: an act of accessing a set of one or more banned territories each associated with one or more operation types that are banned; an act of determining that the location of the requestor is within a banned territory for which the requested operation is expressly banned; and an act of denying the requested operation if the act requested operation is determined to be of an operation type for which the location of the requestor is within any of the corresponding set of one or more banned locations.

The computer program product may further include computer-executable instructions further structured such that, when executed by the one or more processors, further cause the computing system to further perform the following: an act of transcoding the file system entity to be a transcoded file system entity that is suitable for an operating system of the requestor.

Also described herein is a computing system that includes one or more computer-readable storage media having thereon a plurality of file system entities managed by an operating system of the computing system, at least a particular file system entity of the plurality of files having associated location data that is associated with the particular file system entity such that the location data and the particular file system entity are moved or copied atomically together; and one or more processors. The one or more computer-readable media may further have thereon computer-executable instructions that are configured such that, when executed by the one or more processors, cause the computing system to performing the following in response to receiving a request to perform an operation on the particular file system location: an act of identify a location associated with a requestor of the request; and an act of using the location data to determine whether or not the requested file operation is permitted on the particular file system entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for controlling access to data based on location of requestor, the method comprising:
an act of associating location data with a file system entity such that the location data and the file system entity are moved or copied atomically together;
an act of receiving a request to perform an operation on the file system entity;
an act of identifying a location status associated with a requestor of the request; and
an act of using the location data of the file system entity and the location status of the requestor to determine whether or not the requested operation is permitted on the file system entity.

2. The method in accordance with claim 1, the act of associating location data with the file system entity comprising:
an act of including the location data in an alternate data stream of the file system entity.

3. The method in accordance with claim 1, the act of associating location data with the file system entity comprises including the location data as one or more properties of the file system entity.

4. The method in accordance with claim 1, the act of using the location data of the file system entity and the location status of the requestor to determine whether or not the requested operation is permitted comprising:
an act of determining that the location status of the requestor is unknown; and
in response to determining that the location status of the requestor is unknown, an act of accessing a default rule defining whether or not the requested operation may be performed; and
an act of determining whether or not the requested operation may be performed based on the default rule.

5. The method in accordance with claim 1, the location status of the requestor being a location of the requestor, the act of using the location data of the file system entity and the location status of the requestor to determine whether or not the requested operation is permitted further comprising the following:
an act of accessing a set of one or more permitted territory each associated with one or more operation types that are permitted;
an act of determining that the location of the requestor is within a permitted territory for which the requested operation is expressly permitted; and
an act of approving the requested operation if the requested operation is determined to be of an operation type for which the location of the requestor is within any of the corresponding set of one or more permitted locations.

6. The method in accordance with claim 1, the location status of the requestor being a location of the requestor, the act of using the location data of the file system entity and the location status of the requestor to determine whether or not the requested operation is permitted further comprising the following:
an act of accessing a set of one or more banned territories each associated with one or more operation types that are banned;
an act of determining that the location of the requestor is within a banned territory for which the requested operation is expressly banned; and
an act of denying the requested operation if the act requested operation is determined to be of an operation type for which the location of the requestor is within any of the corresponding set of one or more banned locations.

7. The method in accordance with claim 1, the location status of the requestor being a location of the requestor, the act of using the location data of the file system entity and the location status of the requestor to determine whether or not the requested operation is permitted comprising:
an act of determining that the location of the requestor is not within an allowed territory for which the requested operation is expressly allowed;
an act of determining that the location of the requestor is not within a banned territory for which the requested operation is expressly banned;
an act of accessing a default rule defining whether or not the requested operation may be performed; and
an act of determining whether or not the requested operation may be performed based on the default rule.

8. The method in accordance with claim 1, the method further comprising the following if it is determined that the requested operation is not permitted:
an act of preventing the requested operation.

9. The method in accordance with claim 1, the method further comprising the following if it is determined that the requested operation is permitted:
an act of causing the requested operation to be performed.

10. The method in accordance with claim 9, the act of causing the requested operation to be performed comprising:
an act of transcoding the file system entity to be a transcoded file system entity that is suitable for an operating system of the requestor.

11. The method in accordance with claim 9, the act of causing the requested file system entity operation to be performed comprising:
an act of transcoding the file system entity to be in a serialization implementation that is implemented by an operating system of the requestor.

12. The method in accordance with claim 1, the file system entity being a file.

13. The method in accordance with claim 1, the file system entity being a directory.

14. The method in accordance with claim 1, the file system entity being a partition.

15. The method in accordance with claim 1, the file system entity being a disk.

16. A computer program product comprising one or more computer-readable storage media having thereon one or more computer-executable instructions that are structured such that, when executed by the one or more processors of the computing system, cause the computing system to perform the following in response to receiving a request to perform an operation on a file system entity that is managed by an operating system, the file system entity having location data associated with the file system entity such that the location data and the file system entity are moved or copied atomically together:
an act of identifying a location status associated with a requestor of the request;
an act of comparing the location status of the requestor against the location data of the file system entity; and
an act of determining whether or not the requested operation is permitted on the file system entity based on a result of the act of comparing.

17. The computer program product in accordance with claim 16, the location status of the requestor being a location of the requestor, the act of using the location data of the file system entity and the location status of the requestor to determine whether or not the requested operation is permitted further comprising the following:
an act of accessing a set of one or more permitted territory each associated with one or more operation types that are permitted;
an act of determining that the location of the requestor is within a permitted territory for which the requested operation is expressly permitted; and
an act of approving the requested operation if the requested operation is determined to be of an operation type for which the location of the requestor is within any of the corresponding set of one or more permitted locations.

18. The computer program product in accordance with claim 16, the location status of the requestor being a location of the requestor, the act of using the location data of the file system entity and the location status of the requestor to determine whether or not the requested operation is permitted further comprising the following:
an act of accessing a set of one or more banned territories each associated with one or more operation types that are banned;
an act of determining that the location of the requestor is within a banned territory for which the requested operation is expressly banned; and
an act of denying the requested operation if the act requested operation is determined to be of an operation type for which the location of the requestor is within any of the corresponding set of one or more banned locations.

19. The computer program product in accordance with claim 16, the computer-executable instructions further structured such that, when executed by the one or more processors, further cause the computing system to further perform the following:
an act of transcoding the file system entity to be a transcoded file system entity that is suitable for an operating system of the requestor.

20. A computing system comprising:
one or more computer-readable storage media having thereon a plurality of file system entities managed by an operating system of the computing system, at least a particular file system entity of the plurality of files having associated location data that is associated with the particular file system entity such that the location data and the particular file system entity are moved or copied atomically together; and
one or more processors;
the one or more computer-readable media further having thereon computer-executable instructions that are configured such that, when executed by the one or more processors, cause the computing system to performing the following in response to receiving a request to perform an operation on the particular file system location:
an act of identify a location associated with a requestor of the request; and
an act of using the location data to determine whether or not the requested file operation is permitted on the particular file system entity.
